(19) United States
(12) Patent Application Publication
(10) Pub. No.: US 2012/0063644 A1
(43) Pub. Date: Mar. 15, 2012

(54) DISTANCE-BASED POSITION TRACKING METHOD AND SYSTEM

(75) Inventor: Aleksandra Popovic, New York, NY (US)

(73) Assignee: KONINKLIJKE PHILIPS ELECTRONICS N.V., EINDHOVEN (NL)

(21) Appl. No.: 13/321,222

(22) PCT Filed: May 14, 2010
(86) PCT No.: PCT/IB2010/052150

§ 371 Date: Nov. 18, 2011

Related U.S. Application Data
(60) Provisional application No. 61/182,767, filed on Jun. 1, 2009.

(51) Int. Cl. G06K 9/00

(52) U.S. Cl. 382/103

(57) ABSTRACT

A pre-operative stage of a distance-based position tracking method (30) involves a generation of virtual information (21) derived from a scan image (20) illustrating an anatomical region (40) of a body during a virtual navigation of a surgical tool (51) relative to a surgical path (52) within scan image (20). The virtual information (21) includes a prediction of virtual poses of surgical tool (51) relative to surgical path (52) within scan image (20) associated with measurements of a virtual distance of surgical tool (51) from an object within scan image (20). An intra-operative stage of the method (30) involves a generation of tracking information (23) derived from measurements of a physical distance of surgical tool (51) from the object within anatomical region (40) during a physical navigation of surgical tool (51) relative to surgical path (52) within anatomical region (40). The tracking information (23) includes an estimation of poses of surgical tool (51) relative to surgical path (52) within anatomical region (40) corresponding to the prediction of virtual poses of surgical tool (51) relative to surgical path (52) within scan image (20).

The present invention relates to a distance-based position tracking of a surgical tool (e.g., a catheter, an endoscope or a nested cannula) within an anatomical region of a body to provide intra-operative information about the poses (i.e., locations and orientations) of the surgical tool within the anatomical region of the body as related to a pre-operative scan image of the anatomical region of the body.

One known method for spatial localization of the surgical tool is to use electromagnetic (“EM”) tracking. However, this solution involves additional devices, such as, for example, an external field generator and coils in the surgical tool. In addition, accuracy may suffer due to field distortion introduced by the metal of the bronchoscope or other object in vicinity of the surgical field. Furthermore, a registration procedure in EM tracking involves setting the relationship between the external coordinate system (e.g., coordinate system of the EM field generator or coordinate system of a dynamic reference base) and the computed tomography (“CT”) image space. Typically, the registration is performed by point-to-point matching, which causes additional latency. Even with registration, patient motion such as breathing can mean errors between the actual and computed location.

A known method for image guidance of a surgical tool involves a tracking of a tool with an optical position tracking system. In order to localize the tool tip in a CT coordinate system or a magnetic resonance imaging (“MRI”) coordinate system, the tool has to be equipped with a tracked rigid body having infrared (“IR”) reflecting spheres. Registration and calibration has to be performed prior to tool insertion to be able to track the tool position and associate it to the position on the CT or MRI.

If an endoscope is used as a surgical tool, another known method for spatial localization of the endoscope is to register the pre-operative three-dimensional (“3D”) dataset with two-dimensional (“2D”) endoscopic images from a bronchoscope. Specifically, images from a video stream are matched with a 3D model of the bronchial tree and related cross sections of camera fly-through to find the relative position of a video frame in the coordinate system of the patient images. The main problem with this 2D/3D registration is complexity. To resolve this problem, 2D/3D registration is supported by EM tracking to first obtain a coarse registration that is followed by a fine-tuning of transformation parameters via the 2D/3D registration.

The present invention is premised on a utilization of a pre-operative plan to generate virtual measurements of a distance of a surgical tool (e.g., a catheter, an endoscope or a nested cannula) from an object within a pre-operative scan image of an anatomical region of a body taken by an external imaging system (e.g., CT, MRI, ultrasound, x-ray and other external imaging systems). For example, as will be further explained herein, a virtual navigation in accordance with the present invention is a pre-operative endoscopic procedure using the kinematic properties of a surgical tool to generate a kinematically correct tool path within the scan image of the subject anatomical region (e.g., a bronchial tree), and to virtually simulate an execution of the pre-operative plan by the tool within the scan image whereby the virtual simulation includes one or more distance sensors virtually coupled to the surgical tool providing virtual measurements of a distance of the tool from the object (e.g., bronchial wall) within the scan image of the anatomical region.

In the context of the surgical tool being a catheter, an endoscope or a needle, a path planning technique taught by International Application WO 2007/042986 A2 to Trovato et al. published Apr. 17, 2007, and entitled “3D Tool Path Planning, Simulation and Control System” may be used to generate a kinematically correct path for the catheter, the endoscope or the needle within the anatomical region of the body as indicated by the 3D dataset of the subject anatomical region.

In the context of the surgical tool being an imaging nested cannula, the path planning/nested cannula configuration technique taught by International Application WO 2008/032230 A1 to Trovato et al. published Mar. 20, 2008, and entitled “Active Cannula Configuration For Minimally Invasive Surgery” may be used to generate a, kinematically correct path for the nested cannula within the anatomical region of the body as indicated by the 3D dataset of the subject anatomical region.

The present invention is further premised on a utilization of signal matching techniques to compare the pre-operative virtual measurements of a distance of the surgical tool from an object within the 3D scan image of the anatomical region to intra-operative physical measurements by one or more distance sensors physically coupled to the surgical tool of a distance of the surgical tool from the object within the anatomical region. Examples of signal matching techniques known in the art include, but are not limited to, (1) Yu.-Te. Wu, Li-Fen Chen, Po-Lei Lee, Tzu-Chen Yeh, Jen-Chuen Hsieh, “Discrete signal matching using coarse-to-fine wavelet basis functions”, Pattern RecognitionVolume 36, Issue 1, January 2003, Pages 171-192; (2) Dragotti, P. L. Vetterli, M. “Wavelet footprints: theory, algorithms, and applications”, Signal Processing, IEEE Transactions on, Volume: 51, Issue: 5, pp. 1306-1323; and (3) Jong-Eun Byun, Ta-i Nagata, “Determining the 3-D pose of a flexible object by stereo matching of curvature representations”, Pattern RecognitionVolume 29, Issue 8, August 1996, Pages 1297-1307.

One form of the present invention is a position tracking method having a pre-operative stage involving a generation of a scan image illustrating an anatomical region of a body, and a generation of virtual information during a virtual simulation of the surgical tool relative to a surgical path within the scan image. The virtual information includes a prediction of virtual poses of a surgical tool within the scan image associated with measurements of a virtual distance of the surgical tool from an object within the scan image.

In an exemplary embodiment of the pre-operative stage, the scan image and the kinematic properties of the surgical tool are used to generate the surgical path within the scan image. Thereafter, the sensing properties of one or more virtual distance sensor(s) virtually coupled to the surgical tool are used to simulate virtual sensing signal(s) indicative of measurements of the distance of the surgical tool from object walls within the scan image as a flythrough of the surgical path within the scan image is executed and sample points of the virtual sensing signals provided by the distance sensors are stored in a database.

The position tracking method further has an intra-operative stage involving a generation of measurements of a physical distance of the surgical tool from the object walls within the anatomical region during a physical navigation of the surgical tool relative to the surgical path within the anatomical region, and a generation of tracking information derived from a matching of the physical distance measurements to the virtual distance measurements. The tracking information includes an estimation of poses of the surgical tool relative to the endoscopic path within the anatomical region corresponding to the prediction of virtual poses of the surgical tool relative to the surgical path within the scan image.

In an exemplary embodiment of the intra-operative stage, the distance sensor(s) physically coupled to the surgical tool provide physical sensing signal(s) indicative of the physical measurements of the distance of the surgical tool from object within the anatomical region, and the physical sensing signal(s) are matched with the stored virtual sensing signal(s) to determine poses (i.e., locations and orientations) of the surgical tool within the anatomical region during the physical navigation of the surgical tool relative to the surgical path within the anatomical region.

For purposes of the present invention, the term “generating” as used herein is broadly defined to encompass any technique presently or subsequently known in the art for creating, supplying, furnishing, obtaining, producing, forming, developing, evolving, modifying, transforming, altering or otherwise making available information (e.g., data, text, images, voice and video) for computer processing and memory storage/retrieval purposes, particularly image datasets and video frames. Additionally, the phrase “derived from” as used herein is broadly defined to encompass any technique presently or subsequently known in the art for generating a target set of information from a source set of information.

Additionally, the term “pre-operative” as used herein is broadly defined to describe any activity occurring or related to a period or preparations before an endoscopic application (e.g., path planning for an endoscope) and the term “intra-operative” as used herein is broadly defined to describe as any activity occurring, carried out, or encountered in the course of an endoscopic application (e.g., operating the endoscope in accordance with the planned path). Examples of an endoscopic application include, but are not limited to, a bronchoscopy, a colonscopy, a laparoscopy, and a brain endoscopy.

In most cases, the pre-operative activities and intra-operative activities will occur during distinctly separate time periods. Nonetheless, the present invention encompasses cases involving an overlap to any degree of pre-operative and intra-operative time periods.

Furthermore, the term “endoscope” is broadly defined herein as any device having the ability to image from inside a body, and the term “distance sensor” is broadly defined herein as any device having the ability to sense a distance from an object without any physical contact with the object. Examples of an endoscope for purposes of the present invention include, but are not limited to, any type of scope, flexible or rigid (e.g., arthroscope, bronchoscope, choledochoscope, colonoscope, cystoscope, duodenoscope, gastroscope, hysteroscope, laparoscope, laryngoscope, neuroscope, otoscope, push enteroscope, rhinolaryngoscope, sigmoidoscope, sinuscope, thorascope, etc.) and any device similar to a scope that is equipped with an image system (e.g., a nested cannula with imaging). The imaging is local, and surface images may be obtained optically with fiber optics, lenses, or miniaturized (e.g. CCD based) imaging systems. Examples of a distance sensor for purposes of the present invention include, but are not limited to, devices incorporating a reflected light triangulation technique, a time-of-flight acoustic measurement technique, a time-of flight electromagnetic wave technique, an optical interferometry technique, and/or a vibrating light source technique, all of which are known in the art. In particular, a distance sensor designed from microelectromechanical system technology may provide precise sensing in the millimetric space.

The foregoing form and other forms of the present invention as well as various features and advantages of the present invention will become further apparent from the following detailed description of various embodiments of the present invention read in conjunction with the accompanying drawings. The detailed description and drawings are merely illustrative of the present invention rather than limiting, the scope of the present invention being defined by the appended claims and equivalents thereof.

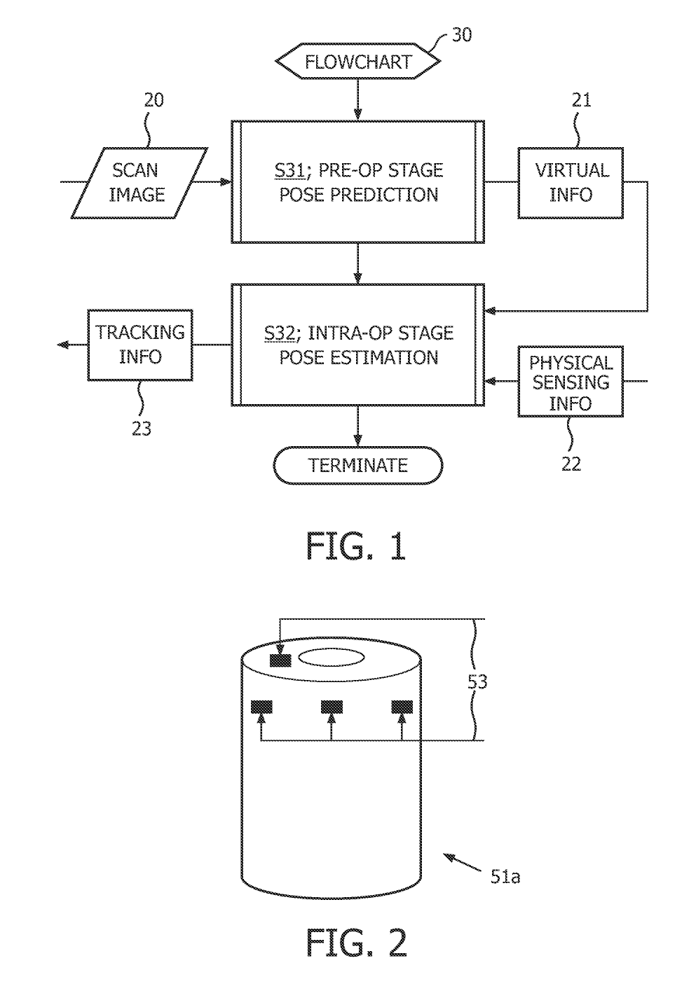

FIG. 1 illustrates a flowchart representative of one embodiment of a distance-based position tracking method of the present invention.

FIG. 2 illustrates an exemplary distance sensor configuration for an endoscope in accordance with the present invention;

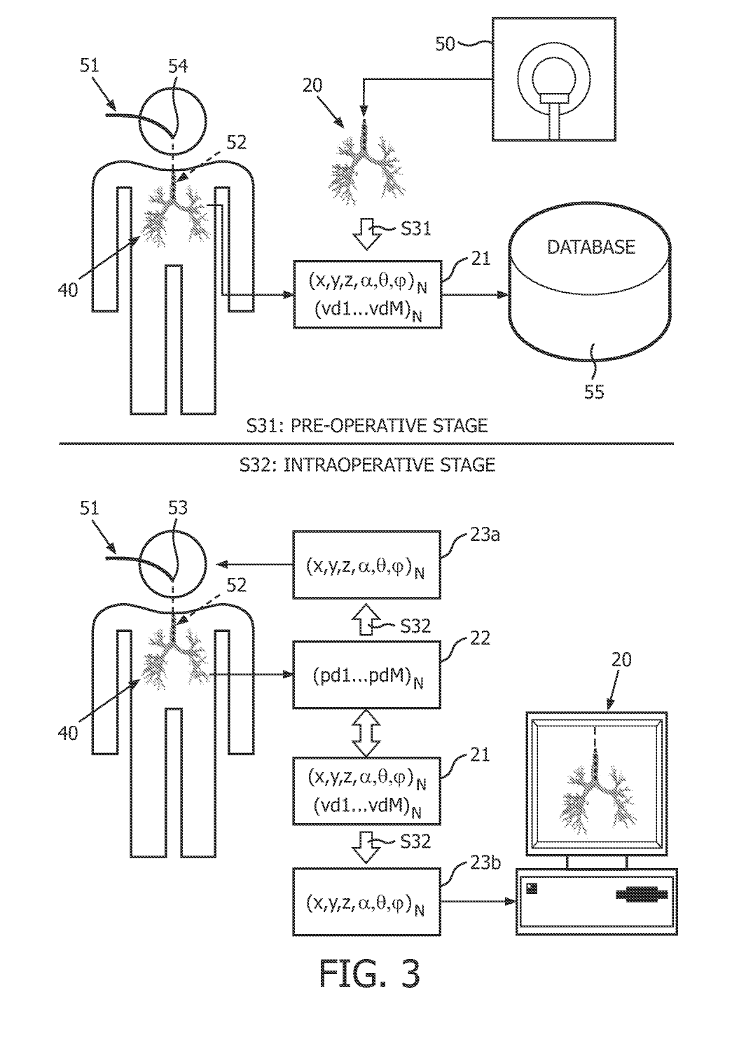

FIG. 3 illustrates an exemplary surgical application of the flowchart illustrated in FIG. 1.

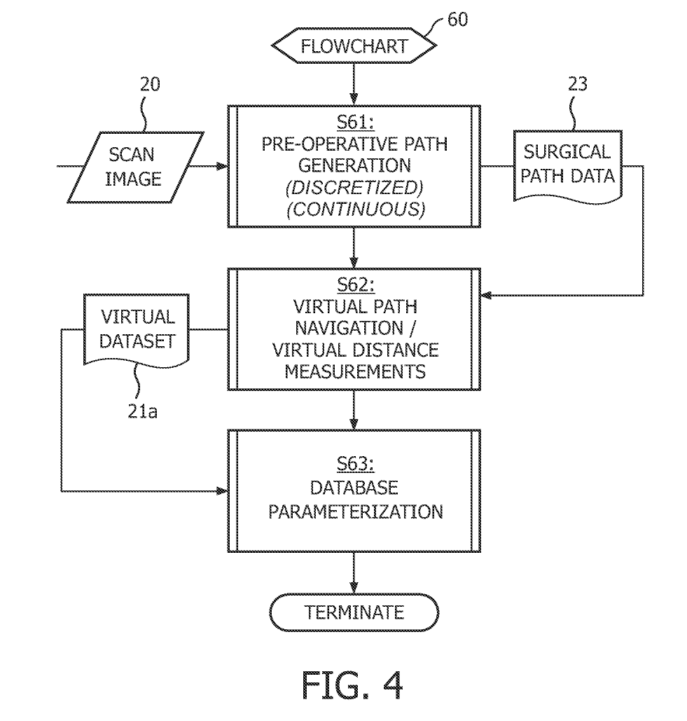

FIG. 4 illustrates a flowchart representative of one embodiment of a pose prediction method of the present invention.

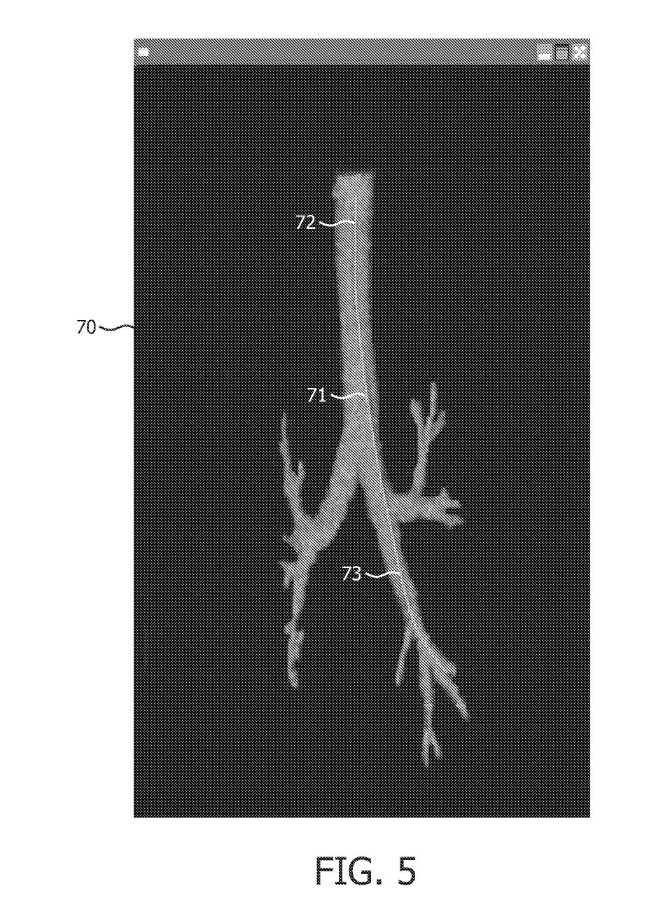

FIG. 5 illustrates an exemplary surgical path generation for a bronchoscope in accordance with the flowchart illustrated in FIG. 4.

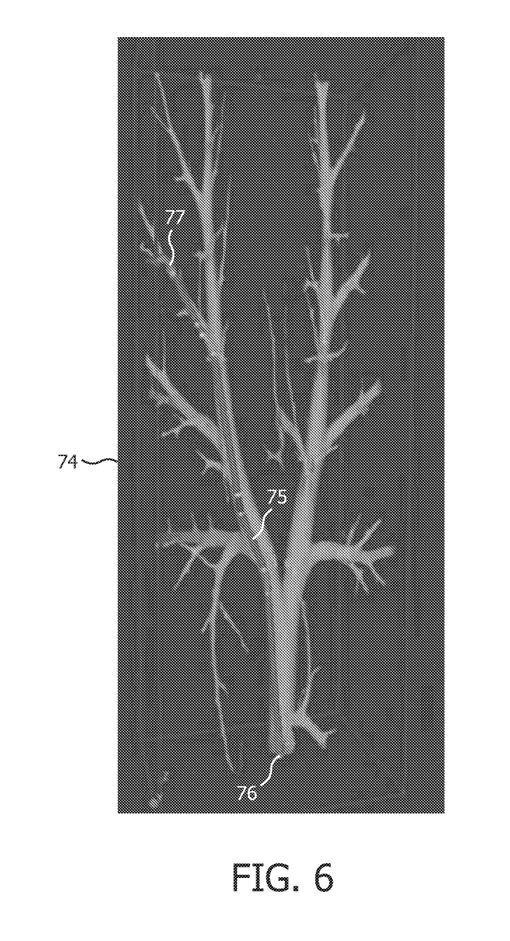

FIG. 6 illustrates an exemplary surgical path generation for a nested cannula in accordance with the flowchart illustrated in FIG. 4.

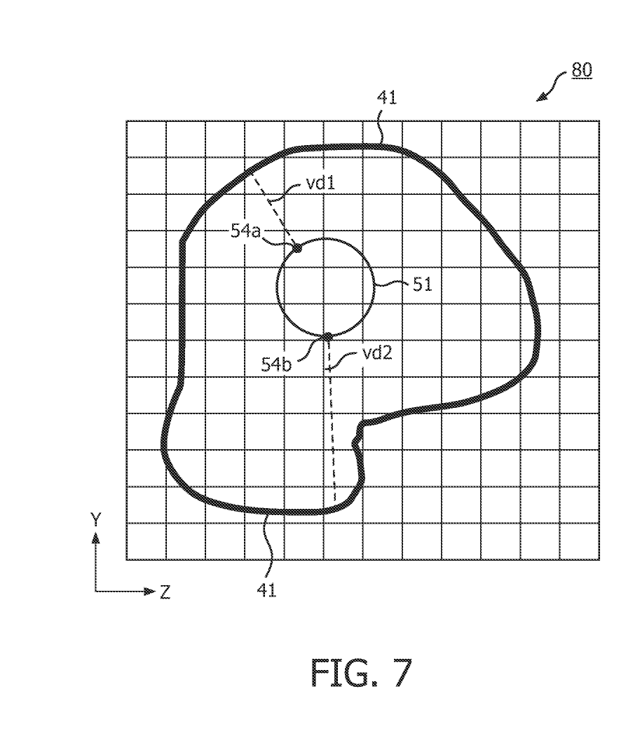

FIG. 7 illustrates an exemplary virtual measurement in accordance with the flowchart illustrated in FIG. 4.

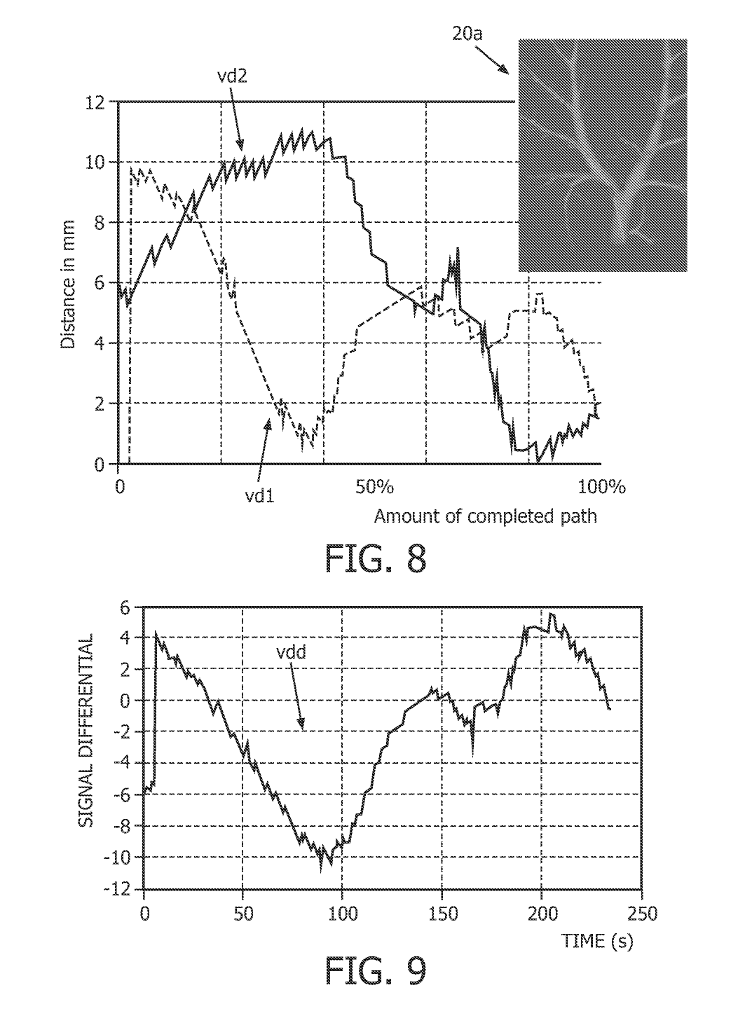

FIG. 8 illustrates a first exemplary virtual signal generation in accordance with the flowchart illustrated in FIG. 4.

FIG. 9 illustrates a second exemplary virtual signal generation in accordance with the flowchart illustrated in FIG. 4.

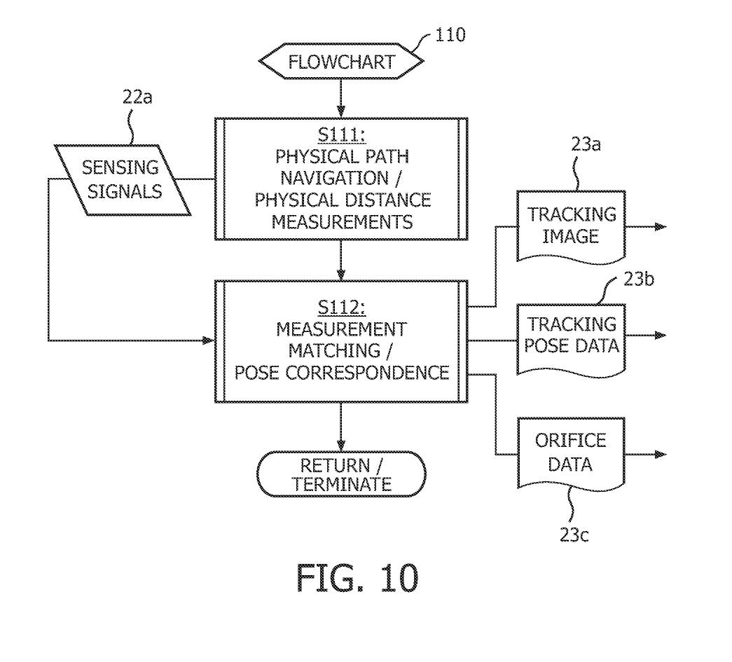

FIG. 10 illustrates a flowchart representative of one embodiment of a pose estimation method of the present invention.

FIG. 11 illustrates an exemplary physical measurement in accordance with the flowchart illustrated in FIG. 10.

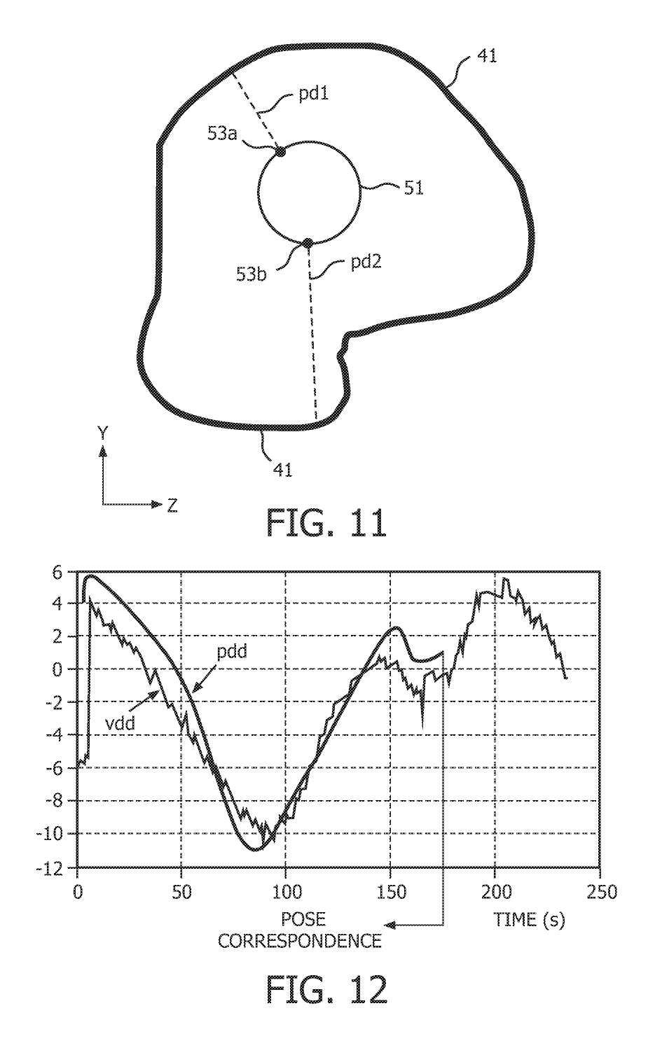

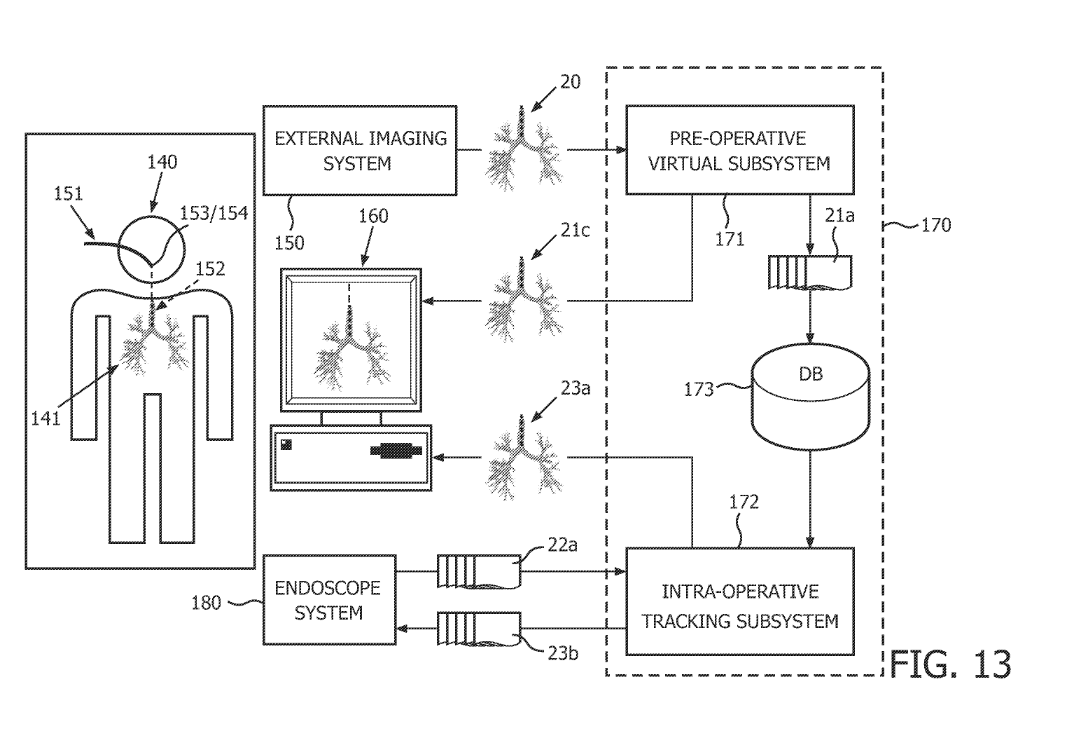

FIG. 12 illustrates an exemplary signal matching in accordance with the flowchart illustrated in FIG. 10.

FIG. 13 illustrates one embodiment of a distance-based position tracking system of the present invention.

A flowchart 30 representative of a distance-based position tracking method of the present invention is shown in FIG. 1. Referring to FIG. 1, flowchart 30 is divided into a pre-operative stage S31 and an intra-operative stage S32.

Pre-operative stage S31 encompasses an external imaging system (e.g., CT, MRI, ultrasound, X-ray, etc.) scanning an anatomical region of a body, human or animal, to obtain a scan image 20 of the subject anatomical region. Based on a possible need for diagnosis or therapy during intra-operative stage S32, a virtual navigation by a surgical tool of the subject anatomical region is executed in accordance with a pre-operative surgical procedure. Virtual information detailing poses of the surgical tool predicted from the virtual navigation including associated measurements of a virtual distance of the surgical tool from an object within the scan image is generated for purposes of estimating poses of the surgical tool within the anatomical region during intra-operative stage S32 as will be subsequently described herein.

For example, as shown in the exemplary pre-operative stage S31 of FIG. 3, a CT scanner 50 may be used to scan bronchial tree 40 of a patient resulting in a 3D image 20 of bronchial tree 40. A virtual surgical procedure of bronchial tree 40 may be executed thereafter based on a need to perform a minimally invasive surgery of bronchial tree 40 during intra-operative stage S32. Specifically, a planned path technique using scan image 20 and kinematic properties of a surgical tool 51 (e.g., an endoscope) may be executed to generate a surgical path 52 for surgical tool 51 through bronchial tree 40, and an image processing technique using scan image 20 may be executed to simulate surgical tool 51 traversing surgical path 52 within bronchial tree 40. Virtual information 21 detailing N predicted virtual locations (x,y,z) and orientations (α,θ,φ) of surgical tool 51 within scan image 20 derived from the virtual navigation may thereafter be immediately processed and/or stored in a database 54 for purposes of the surgery.

The present invention provides for a virtual navigation of a M number of physical distance sensors 53 physically coupled to surgical tool 51 during the virtual navigation, preferably to a tip 51a of surgical tool and around a circumference of surgical tool 51 adjacent tip 51a as shown in FIG. 2. In one exemplary embodiment, the virtual navigation of distance sensors 53 is accomplished by environment perceiving software elements 54 shown in FIG. 3 configured to simulate physical measurements by distance sensors 53. In practice, the present invention does not impose any restrictions or any limitations to the M number of virtual distance sensors 54 (i.e., M≧1) and the particular configuration of distance sensors 54 relative to surgical tool 51, except the quantity of virtual distance sensors 54 and the configuration of virtual distance sensors 54 should be identical to the quantity of physical distance sensors 53 and the actual configuration of physical distance sensors 53 on surgical tool 51. Those having ordinary skill in the art will appreciate that each additional distance sensor 53 coupled to surgical tool increases the accuracy in position tracking surgical tool 51 during intra-operative stage S32 as will be further explained herein. Furthermore, those having ordinary skill in the art will appreciate a uniform distribution of distance sensors 53, particularly in opposing pairs, also increase the accuracy in position tracking surgical tool 51 during intra-operative stage S32.

Referring again to FIG. 3, during the virtual navigation of surgical tool 51, a virtual distance of surgical tool 51 from a bronchial wall of bronchial tree 40 is measured by distance sensor(s) 54 for each predicted pose of surgical tool 51. Virtual information 21 as stored in database 55 includes details of the virtual distance measurements of surgical tool 51 from the bronchial wall of bronchial tree 40. Virtual information 21 stores N samples of poses of the surgical tool (x,y,z,α,θ,φ)_{N} and N measurements from all M virtual sensors (vd1, . . . , vdM)_{N}.

Referring again to FIG. 1, intra-operative stage S32 encompasses a processing of physical sensing information 22 detailing measurements of a physical distance of the surgical tool from an object within the anatomical region during a physical navigation of the surgical tool relative to a surgical path within the anatomical region. Physical sensing values from M physical sensors are (pd10 . . . pdMN). To estimate the poses of the surgical tool within the subject anatomical region, virtual information 21 is referenced to match the virtual distance measurements associated with the predicted virtual poses of the surgical tool (vd10 . . . vdMN) within scan image 20 to the physical distance measurements provided by physical sensing information 22 (pd10 . . . pdMN). This distance measurement matching enables the predicted virtual poses of the surgical tool during the virtual navigation to be utilized as estimated poses of the surgical tool during the physical navigation of the surgical tool. Tracking information 23 detailing the results of the pose correspondence is generated for purposes of controlling the surgical tool to facilitate compliance with the surgical procedure and/or of displaying of the estimated poses of the surgical tool within the anatomical region.

For example, as shown in the exemplary intra-operative stage S32 of FIG. 3, distance sensors 53 generate measurements 22 of a physical distance of surgical tool 53 from the bronchial wall of bronchial tree 40 as surgical tool 51 is operated to traverse surgical path 52. To estimate locations (x,y,z) and orientations (α,θ,φ) of surgical tool 51 in action, virtual distance measurements 21 and physical distance measurements 22 are matched to facilitate a reading from database 55 of the predicted virtual poses of surgical tool 51 within scan image 20 of bronchial tree 40 as estimated poses of surgical tool 51 within bronchial tree 40. Tracking information 23 in the form of a tracking pose data 23b detailing the estimated poses of surgical tool 51 is generated for purposes for providing control data to a surgical tool control mechanism (not shown) of surgical tool 51 to facilitate compliance with the surgical path 52. Additionally, tracking information 23 in the form of tracking pose image 23a illustrating the estimated poses of surgical tool 51 is generated for purposes of displaying the estimated poses of surgical tool 51 within bronchial tree 40 on a display 56.

The preceding description of FIGS. 1-3 teaches the general inventive principles of the position tracking method of the present invention. In practice, the present invention does not impose any restrictions or any limitations to the manner or mode by which flowchart 30 is implemented. Nonetheless, the following descriptions of FIGS. 4-12 teach an exemplary embodiment of flowchart 30 to facilitate a further understanding of the distance-based position tracking method of the present invention.

A flowchart 60 representative of a pose prediction method of the present invention is shown in FIG. 4. Flowchart 60 is an exemplary embodiment of the pre-operative stage S31 of FIG. 1.

Referring to FIG. 4, a stage S61 of flowchart 60 encompasses an execution of a planned path technique (e.g., a fast marching or A* searching technique) using scan image 20 and kinematic properties of the surgical tool to generate a kinematically customized path for the surgical tool within scan image 20. For example, in the context of surgical tool being a a catheter, an endoscope or a needle, a known path planning technique taught by International Application WO 2007/042986 A2 to Trovato et al. dated Apr. 17, 2007, and entitled “3D Tool Path Planning, Simulation and Control System”, an entirety of which is incorporated herein by reference, may be used to generate a kinematically customized path within scan image 20 (e.g., a CT scan dataset). FIG. 5 illustrates an exemplary surgical path 71 for an bronchoscope within a scan image 70 of a bronchial tree. Surgical path 71 extends between an entry location 72 and a target location 73.

Also by example, in the context of the surgical tool being an imaging nested cannula, the path planning/nested cannula configuration technique taught by International Application WO 2008/032230 A1 to Trovato et al. published Mar. 20, 2008, and entitled “Active Cannula Configuration For Minimally Invasive Surgery”, an entirety of which is incorporated herein by reference, may be used to generate a kinematically customized path for the imaging cannula within the subject anatomical region (e.g., a CT scan dataset). FIG. 6 illustrates an exemplary path 75 for an imaging nested cannula within an image 74 of a bronchial tree. Surgical path 75 extends between an entry location 76 and a target location 77.

Continuing in FIG. 4, surgical path data 23 representative of the kinematically customized path in terms of predicted poses (i.e., location and orientation) of the surgical tool relative to the surgical path is generated for purposes of stage S62 of flowchart 60 as will be subsequently explained herein and for purposes of conducting the intra-operative procedure via the surgical tool during intra-operative stage 32 (FIG. 1). A pre-operative path generation method of stage S61 involves a discretized configuration space as known in the art, and surgical path data 23 is generated as a function of the coordinates of the configuration space traversed by the applicable neighborhood. Preferably, stage S61 involves a continuous use of the discretized configuration space in accordance with the present invention, so that the surgical path data 23 is generated as a function of the precise position values of the neighborhood across the discretized configuration space.

The pre-operative path generation method of stage S61 is employed as the path generator because it provides for an accurate kinematically customized path in an inexact discretized configuration space. Further the method enables a 6 dimensional specification of the path to be computed and stored within a 3D space. For example, the configuration space can be based on the 3D obstacle space such as the anisotropic (non-cube voxels) image typically generated by CT. Even though the voxels are discrete and non-cubic, the planner can generate continuous smooth paths, such as a series of connected arcs. This means that far less memory is required and the path can be computed quickly. Choice of discretization will affect the obstacle region, and thus the resulting feasible paths, however. The result is a smooth, kinematically feasible path, in a continuous coordinate system for the surgical tool. This is described in more detail in U.S. Patent Application Ser. Nos. 61/075,886 and 61/099,233 to Trovato et al. filed, respectively, Jun. 26, 2008 and Sep. 23, 2008, and entitled “Method and System for Fast Precise Planning”, an entirety of which is incorporated herein by reference.

Referring back to FIG. 4, a stage S62 of flowchart 60 encompasses a virtual navigation of the surgical tool relative to the surgical path including measurements of a virtual distance of the surgical tool from an object in scan image 20. Specifically, a virtual surgical tool is advanced point by point along the surgical path and a virtual distance of the surgical tool from an object is measured at each path point of the surgical path. This distance sampling will be equal to or greater than the resolution of the physical distance measurements on intra-operative stage S32 (FIG. 1). In one exemplary embodiment, the number N of sampling points is calculated by the following equation [1]:

N>(F/V)*L [1]
where V is the maximum expected speed in millimeter per second of surgical tool navigation during the intra-operative procedure, F is the sampling rate in hertz of the distance sensors 53 and L is the length in millimeters of the surgical path.

For example, referring to FIG. 7 showing a 2D frame 80 of the scan image 20 of a given point X along the path, two (2) virtual distance sensors 54a and 54b virtually coupled to surgical tool 51 respectively measure virtual distances vd1 and vd2 from a bronchial wall 41 of a bronchial tube for the given point X. In particular, distance sensors 54 are described in frame 80 by their respective positions on surgical tool 51 with the distance measure being a vector normal from the sensor surface to bronchial wall 41. In practice, the virtual distance measurements will be performed in 3D of the scan image with each sampling point being taken within the 3D object along the surgical path.

In one exemplary embodiment, as shown in FIG. 8, the virtual distance measurements vd1 and vd2 by respective distance sensors 54a and 54b may be graphed with measured distances on the Y-axis and the percentage of completed path of the X-axis based on surgical tool 51 being navigated through a scan image 20a of a bronchial tube. Alternatively, on as shown in FIG. 9, a differential vdd of the two virtual distance measurements vd1 and vd2 may be graphed with differential vdd being on the Y-axis and time of the virtual navigation being on the X-axis.

Referring back to FIG. 4, a result of stage S62 is a virtual dataset 21a representing, for each sampling point, a unique location (x,y,z) and orientation (α,θ,φ) in the coordinate space of the pre-operative scan image 20 associated with the virtual distance measurements. A stage S63 of flowchart 60 encompasses a storage of virtual dataset 21a within a database having the appropriate parameter fields. The following Table 1 is an example of a storage of virtual dataset 21a within the database.

TABLE 1

| Sampling Point | | Virtual Distance |
|---|---|---|
| Index | Surgical tool Pose | Measurements |
| 0 | x0, y0, z0, α0 ,θ0, φ0 | vd10, vd20 |
| 1 | x1, y1, z1, α1 ,θ1, φ1 | vd11, vd21 |
| . . . | . . . | . . . |
| N | xN, yN, zN, αN ,θN, φN | vd1N, vd2N |

Referring again to FIG. 3, a completion of flowchart 60 results in a parameterized storage of virtual dataset 21a whereby the database will be used to find matches of physical distance measurements during the intra-operative procedure to the virtual distance measurements for each sampling point and to correspond the unique location (x,y,z) and orientation (α,θ,φ) of each sampling point to an estimated location (x,y,z) and orientation (α,θ,φ) of the surgical tool within the anatomical region.

Further to this point, FIG. 10 illustrates a flowchart 110 representative of a pose estimation method of the present invention as an example of intra-operative stage S32 (FIG. 1). A stage S111 of flowchart 110 encompasses a physical navigation of the surgical tool relative to the surgical path through the anatomical region and a measurement of physical distances between the surgical tool an object within the anatomical region.

For example, referring to FIG. 11 showing a cross sectional view of bronchial tree at a given point X along the surgical path, two (2) physical distance sensors 53a and 53b physically coupled to surgical tool 51 respectively measure physical distances pd1 and pd2 from a bronchial wall 41 of a bronchial tube for the given point X. In particular, distance sensors 53 are described their respective positions on surgical tool 51 with the distance measure being a vector normal from the sensor surface to bronchial wall 41.

In one exemplary embodiment, the physical distance measurements pd1 and pd2 by respective distance sensors 53a and 53b may be graphed with measured distances on the Y-axis and the percentage of completed path of the X-axis based on surgical tool 51 being navigated through the bronchial tube relative to the surgical path. Alternatively, as shown in FIG. 12, a differential pdd of the two physical distance measurements pd1 and pd2 may be graphed with differential pdd being on the Y-axis and time of the surgical tool navigation being on the X-axis.

Stage S112 of flowchart 110 encompasses a measurement matching of the physical distance measurements to the virtual distance measurements as the surgical tool is being navigated in stage S111. During stage S111, the physical distance measurements will produce a similar but slightly different signal shape than the virtual distance measurements in view of the different accuracy in the measurements, local changes in the anatomical region (e.g., breathing by a patient) and other factors known to those in the art. However, the uniform sampling of the virtual distance measurements associated with the timing of the physical distance measurements facilitates signal matching for position tracking purposes despite any absolute value differences in the measurements.

In one exemplary embodiment, a single signal shape of each sensor in the virtual world and the physical world may be matched using well-known signal matching techniques, such, as for example, wavelets or least square fitting.

In another exemplary embodiment, a differential between the virtual distance measurements (e.g., differential vdd shown in FIG. 9) and a differential between the physical distance measurements (e.g., differential pdd shown in FIG. 12) may be matched using well-known signal matching techniques, such, as for example, wavelets or least square fitting. In particular, for sensors located opposite from each other on the surgical tool, the distance difference may be assumed to be the same in any phase of a respiratory cycle of the patient.

Stage S112 of flowchart 110 further encompasses a correspondence of the location (x,y,z) and orientation (α,θ,φ) of the surgical tool within the anatomical region to a correspondence of a location (x,y,z) and orientation (α,θ,φ) of the surgical tool within the scanned image based the signal matching to thereby estimate the poses of the surgical tool within the subject anatomical region. More particularly, as shown in FIG. 10, the signal matching achieved in stage S112 enables a correspondence of the location (x,y,z) and orientation (α,θ,φ) of each virtual sampling point of the scan image 20 (FIG. 1) of subject anatomical region to a matched physical distance measurement, which serves as estimations of the poses of the surgical tool within the subject anatomical region.

This pose correspondence facilitates a generation of a tracking pose image 23a illustrating the estimated poses of the surgical tool relative to the surgical path within the subject anatomical region. Specifically, tracking pose image 23a is a version of scan image 20 (FIG. 1) having a surgical tool and surgical path overlay derived from the estimated poses of the surgical tool.

The pose correspondence further facilitates a generation of tracking pose data 23b representing the estimated poses of the surgical tool within the subject anatomical region Specifically, the tracking pose data 23b may have any form (e.g., command form or signal form) to used in a control mechanism of the surgical tool to ensure compliance to the planned surgical path.

Furthermore, for additional information of the available space within the anatomical region, orifice data 23c representing opposing physical distance measurements plus the diameter of the surgical tool at each measurement point along the path may used to augment the navigation of the surgical tool within the subject anatomical region.

FIG. 13 illustrates an exemplary system 170 for implementing the various methods of the present invention. Referring to FIG. 13, during a pre-operative stage, an imaging system external to a patient 140 is used to scan an anatomical region of patent 140 (e.g., a CT scan of bronchial tubes 141) to provide scan image 20 illustrative of the anatomical region. A pre-operative virtual subsystem 171 of system 170 implements pre-operative stage S31 (FIG. 1), or more particularly, flowchart 60 (FIG. 3) to display a visual simulation 21b of the relevant pre-operative surgical procedure via a display 160, and to store virtual dataset 21a into a parameterized database 173. The virtual information details the sampling of the virtual distance measurements by virtual distance sensors 154 coupled to surgical tool 151 as previously described herein.

During an intra-operative stage, a surgical tool control mechanism (not shown) of system 180 is operated to control an insertion of the surgical tool within the anatomical region in accordance with the planned surgical path therein. System 180 provides physical sensing information 22a provided by physical distance sensors 153 coupled to surgical tool 151 to an intra-operative tracking subsystem 172 of system 170, which implements intra-operative stage S32 (FIG. 1), or more particularly, flowchart 110 (FIG. 9) to display tracking image 23a to display 160, and/or to provide tracking pose data 23b to system 180 for control feedback purposes. Tracking image 23a and tracking pose data 23b are collectively informative of a surgical path of the physical surgical tool through the anatomical region (e.g., a real-time tracking of surgical tool 151 through bronchial tree 141). In the case where system 172 fails to achieve a signal match between the distance measurements, tracking pose data 23b will contain an error message signifying the failure.

While various embodiments of the present invention have been illustrated and described, it will be understood by those skilled in the art that the methods and the system as described herein are illustrative, and various changes and modifications may be made and equivalents may be substituted for elements thereof without departing from the true scope of the present invention. In addition, many modifications may be made to adapt the teachings of the present invention to entity path planning without departing from its central scope. Therefore, it is intended that the present invention not be limited to the particular embodiments disclosed as the best mode contemplated for carrying out the present invention, but that the present invention include all embodiments falling within the scope of the appended claims.

1. An position tracking method (30), comprising:
generating a scan image (20) illustrating an anatomical region (40) of a body;
generating a surgical path (52) within the scan image (20) in accordance with kinematic properties of a surgical tool (51);
executing a virtual navigation of a surgical tool (51) relative to the surgical path (52) within the scan image (20); and
generating measurements of a virtual distance of the surgical tool (51) from an object within the scan image (20) during the virtual navigation of the surgical tool (51).

2. The position tracking method (30) of claim 1, further comprising:
executing a physical navigation of the surgical tool (51) relative to the surgical path (52) within the anatomical region (40); and
generating measurements of a physical distance of the surgical tool (51) from the object within the anatomical region (40) during the physical navigation of the surgical tool (51).

3. The position tracking method (30) of claim 2, wherein at least one distance sensor (53) is virtually coupled to the surgical tool (51) during the virtual navigation of the surgical tool (51) within the scan image (20) and physically coupled to the surgical tool (51) during the physical navigation of the surgical tool (51) within the anatomical region (40).

4. The position tracking method (30) of claim 2, further comprising:
matching the physical distance measurements to the virtual distance measurements; and
tracking poses of the surgical tool (51) within the anatomical region (40) as a function of the matching of the physical distance measurements to the virtual distance measurements.

5. The position tracking method (30) of claim 4, wherein the matching of the physical distance measurements to the virtual distance measurements includes:
shape matching the physical distance measurements to the virtual distance measurements.

6. The position tracking method (30) of claim 4, wherein the matching of the physical distance measurements to the virtual distance measurements includes:
difference matching the physical distance measurements to the virtual distance measurements.

7. The position tracking method (30) of claim 1, further comprising:
associating predicated poses of the surgical tool (51) relative to the surgical path (52) within the scan image (20) to the virtual distance measurements; and
generating a parameterized database (55) including a virtual pose dataset (21a) representative of the associations of the predicted poses of the surgical tool (51) relative to the surgical path (52) within the scan image (20) to the virtual distance measurements.

8. The position tracking method (30) of claim 7, further comprising:
executing a physical navigation of the surgical tool (51) relative to the surgical path (52) within the anatomical region (40);
generating measurements of a physical distance of the surgical tool (51) from the object within the anatomical region (40) during the physical navigation of the surgical tool (51); and
reading the virtual pose dataset (21a) from the parameterized database (55) as a function of a matching of the physical distance measurements to the virtual distance measurements.

9. The distance-based position tracking method (30) of claim 8, further comprising:
generating a tracking pose image (23a) illustrating estimated poses of the surgical tool (51) within the anatomical region (40) corresponding to the reading of the virtual pose dataset (21a); and
providing the tracking pose image (23a) to a display (56).

10. The distance-based position tracking method (30) of claim 8, further comprising:
generating a tracking pose dataset (23b) representing estimated poses of the surgical tool (51) within the anatomical region (40) corresponding to the reading of the virtual pose dataset (21a); and
providing the tracking pose data (23b) to a surgical tool control mechanism (180) of the surgical tool (51).

11. An distance-based position tracking method (30), comprising:
generating a scan image (20) illustrating an anatomical region (40) of a body; and
generating virtual information (21) during a virtual navigation of a surgical tool (51) relative to a surgical path (52) within the scan image (20),
wherein the virtual information (21) includes a prediction of virtual poses of a surgical tool (51) relative to the surgical path (52) within the scan image (20) associated with measurements of a virtual distance of the surgical tool (51) from an object within the scan image (20).

12. The distance-based position tracking method (30) of claim 11, further comprising:
generating measurements of a physical distance of the surgical tool (51) from the object within the anatomical region (40) during a physical navigation of the surgical tool (51) relative to the surgical path (52) within the anatomical region (40); and
generating tracking information (23) derived from a matching of the physical distance measurements to the virtual distance measurements,
wherein the tracking information (23) includes an estimation of poses of the surgical tool (51) relative to the surgical path (52) within the anatomical region (40) corresponding to the prediction of virtual poses of the surgical tool (51) relative to the surgical path (52) within the scan image (20).

13. A distance-based position tracking system, comprising;
a pre-operative virtual subsystem (171) operable to generate virtual information (21) derived from a scan image (20) illustrating an anatomical region (40) of the body during a virtual navigation of a surgical tool (51) relative to a surgical path (52) within the scan image (20),
wherein the virtual information (21) includes a prediction of virtual poses of the surgical tool (51) relative to the surgical path (52) within the scan image (20) associated with measurements of a virtual distance of the surgical tool (51) from an object within the scan image (20); and
an intra-operative tracking subsystem (172) operable to generate tracking information (23) derived from measurements of a physical distance of the surgical tool (51) from the object within the anatomical region (40) during a physical navigation of the surgical tool (51) relative to the surgical path (52) within the anatomical region (40),
wherein the tracking information (23) includes an estimation of poses of the surgical tool (51) relative to the surgical path (52) within the anatomical region (40) corresponding to the prediction of virtual poses of the surgical tool (51) relative to the surgical path (52) within the scan image (20).

14. The distance-based position tracking system of claim 13, further comprising:
a display (160),
wherein the intra-operative tracking subsystem (172) is further operable to provide a tracking pose image (23a) illustrating the estimated poses of the surgical tool (51) relative to the surgical path (52) within the anatomical region (40) to the display (56).

15. The distance-based position tracking system of claim 13, further comprising:
a surgical control mechanism (180),
wherein the intra-operative tracking subsystem (172) is further operable to provide a tracking pose dataset (23b) representing the estimated poses of the surgical tool (51) relative to the surgical path (52) within the anatomical region (40) to the surgical control mechanism (180).

16. The distance-based position tracking system of claim 13, wherein the surgical tool (51) is one of a surgical tool group including a catheter, an endoscope, a needle, and a nested cannula.
